(19) United States
(12) Patent Application Publication
(10) Pub. No.: US 2006/0095863 A1
(43) Pub. Date: May 4, 2006

(54) Creating views on a computer screen

(75) Inventor: Marco Van Leeuwen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/541,992

(22) PCT Filed: Dec. 5, 2003
(86) PCT No.: PCT/IB03/05828

§ 371 Date: Jul. 11, 2005

(30) Foreign Application Priority Data
Jan. 14, 2003 (EP) 03100055.7

(51) Int. Cl. G06F 9/00; G06F 3/00

(52) U.S. Cl. 715/788; 715/789; 715/798; 715/800

(57) ABSTRACT

To create a new view on a computer screen (3), the computer receives a request from a user, the request comprising location information such as a point indicated by the user. On the basis of the location information, the computer determines both the location of the new view and its dimensions. The point indicated by the user may constitute the center of the new view, the dimensions being as large as possible considering the size of the screen. A grid of activation points (P) may be displayed on the screen, each point corresponding to a predetermined view size.

The present invention relates to a method of creating views on a computer screen. More in particular, the present invention relates to a method of creating a view on a computer screen, as well as to a device in which the method is employed and a software product for carrying out the method.

It is well known to generate and display views on a computer screen. In Microsoft's Windows® operating system, for example, a new view or “window” is opened for every program activated by the user. The views allow a user to interact with the particular program or to read information presented in the view. Such views are also used in hand-held devices such as PDAs (Personal Digital Assistants) and palm-top computers.

Typically, when a view is created, the computer assigns the view both standard dimensions and a standard or random location on the computer screen. The user may alter the dimensions of the view to suit her needs and may also change its location. In this way, the appearance of the view may be adapted to the needs of the user.

The views could be used for showing pictures or movies, displaying news items, displaying a clock, or interacting with an interactive computer application such as a word processor. When using several applications or sources of information at the same time, several views should be displayed simultaneously on the screen.

The user may wish to arrange the views such that they do not overlap. This can be achieved by reducing the dimensions of all views until they do not overlap, and then rearranging and/or resizing the views in any convenient manner. Alternatively, the user or the software manufacturer may program the views in such a way that certain preferred views, when activated, automatically appear in a convenient arrangement.

Microsoft Windows® (versions 98 and XP) has an in-built feature called “windows tiling” which allows the active views to be automatically rearranged on the screen in a non-overlapping arrangement. This involves re-sizing the views to fit the views on the screen. However, the user may not want to resize certain views.

It is an object of the present invention to overcome these and other problems of the Prior Art and to provide a method of creating views on a screen which allows the user to determine the size of the views in a simple manner.

It is another object of the present invention to provide a method of creating views on a screen which avoids overlap.

It is a further object of the present invention to provide a software product for creating views on a screen, and an information carrier provided with such a software product.

Accordingly, the present invention provides a method of creating a view on a computer screen, the method comprising the steps of:

the computer receiving a request from a user to create a view, the request comprising a location indication,

the computer determining, on the basis of the location information, both a view location and view dimensions,

the computer displaying a view having said view location and said view dimensions.

That is, the user provides a request to create a new view, which request includes a location indication. The computer, or strictly speaking the software program being executed by the computer, then determines both the location of the view and its dimensions on the basis of the location indication. Therefore a view is created the size of which are determined by the location information.

There are various ways of providing location indication, for instance by identifying a quadrant of the screen by means of its position relative to the center, for instance NE (North East), and typing the corresponding letters on a keyboard. However, it is preferred that the location indication comprises a point on the screen indicated by the user. The user may indicate the point on the screen using a pointing device such as a mouse or a touch pad, arrow (cursor) keys, or other means, such as a touch screen.

The point indicated by the user could constitute a corner of the view to be created. In a preferred embodiment, however, the view has a geometric center which substantially coincides with the point on the screen indicated by the user. That is, the center of the new view is located at, or near, the point indicated by the user. The computer may slightly adjust the center if necessary to achieve a convenient location of the view.

In an advantageous embodiment of the present invention, the view dimensions are as large as possible. That is, the dimensions are maximized, given the location of the view. In practice this means that the dimensions are determined by the proximity of the edges of the screen: a view created in the middle of the screen will be larger than one created closer to the edges.

In principle any location of the screen, and when a point is indicated any point on the screen, may be used as location information. This provides the greatest freedom with respect to the location of the view. In a preferred embodiment, however, the computer provides view activation points on the screen, each view activation point corresponding with a view having predetermined view dimensions. These activation points may be visible or invisible.

In this embodiment, therefore, a limited number of points on the screen can be used as activation points, the remainder of the screen not being capable of activating the creation of a new view. These activation points may be software buttons that for example can be activated by clicking. By providing a limited number of activation points, preferably arranged in a regular grid pattern, a more efficient use of the screen surface may be achieved. In addition, the dimensions corresponding with the respective activation points may be predetermined, thus saving computing time.

Although all activation points could be of the same type, each for example corresponding with the largest view possible having the activation point at its geometric center, this is not necessarily the case. In an advantageous embodiment the computer provides at least two different types of view activation points, one type corresponding with views having a fixed size. This would for example provide the possibility of creating views which do not have the maximum dimensions possible.

To avoid overlap, it is preferred that views can only be created using points of the screen where no view is present. In the embodiments having selected activation points, when a view is created, it will cover and make inoperative at least one such activation point.

The present invention additionally provides a device, such as a computer, programmed for carrying out the method defined above. The present invention further provides a software product for carrying out the method defined above, as well as an information carrier, such as a floppy disk, DVD or CD-ROM, provided with such a software product.

The present invention will further be explained below with reference to exemplary embodiments illustrated in the accompanying drawings, in which:

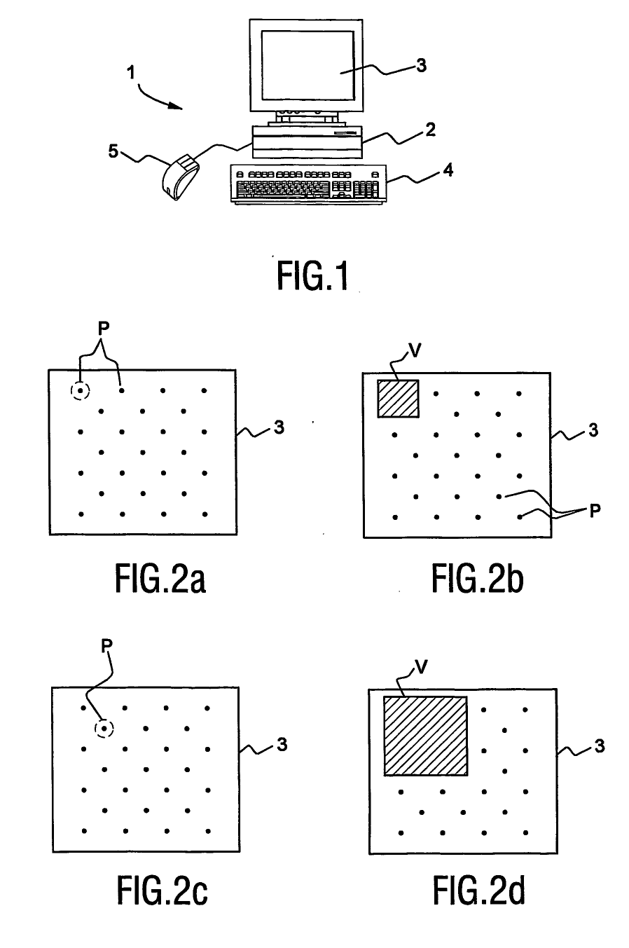

FIG. 1 schematically shows a computer system in which the present invention may be utilized.

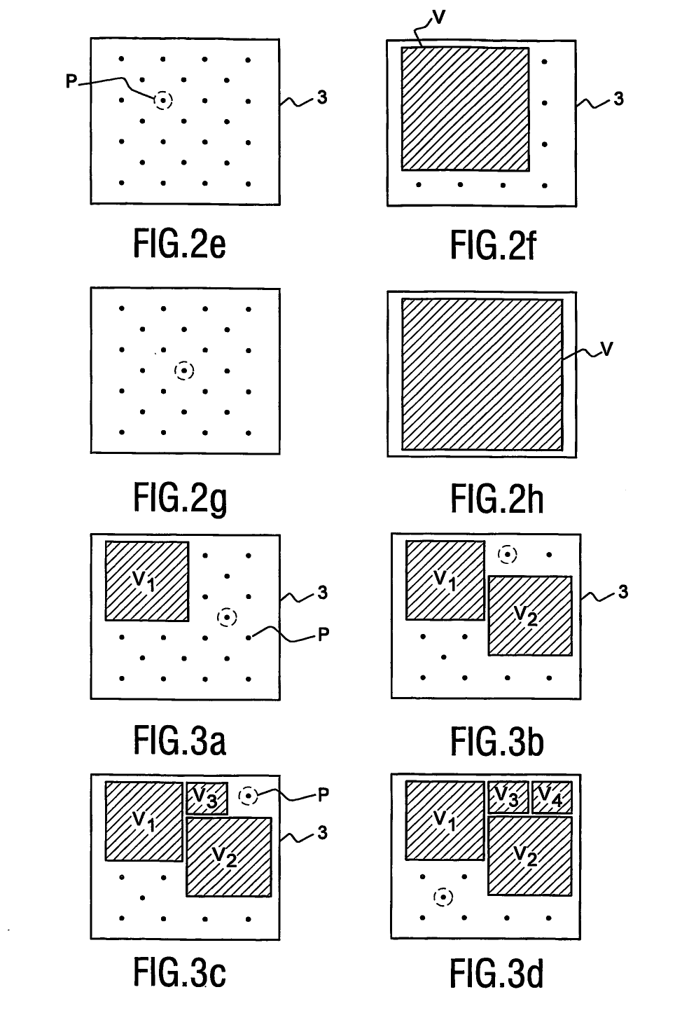

FIG. 2 schematically shows a first embodiment of a method according to the present invention.

FIG. 3 schematically shows a second embodiment of a method according to the present invention.

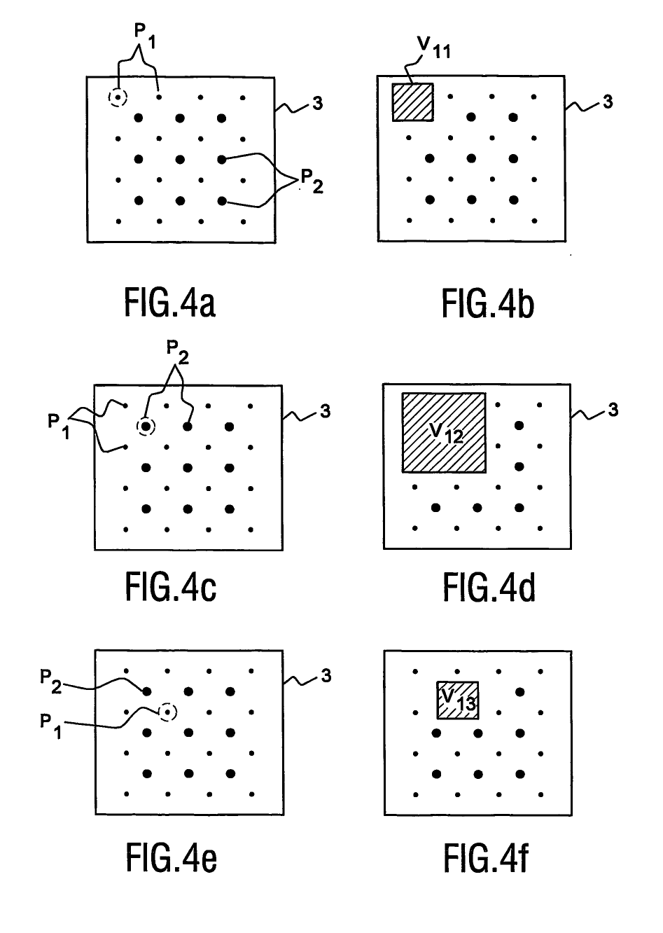

FIG. 4 schematically shows how an arrangement of views on a computer screen is obtained using the present invention.

The computer system 1 shown merely by way of non-limiting example in FIG. 1 comprises a computer unit 2 connected to a display screen 3, a keyboard 4 and a mouse 5. The computer unit 2 executes various software programs, including an operating system having a graphical user interface such as Microsoft Windows® or operating systems marketed by Apple Computer Inc. The computer unit 2 also executes a software program for carrying out the method of the present invention, as well as several other software programs. Although a desktop computer system is shown in FIG. 1, the present invention is not so limited and is equally applicable to laptop computers, palmtop computers, PDAs (Personal Digital Assistants), electronic organizers, etc.

On the screen 3 of the computer system 1, several views may be displayed, each view corresponding with an active software program or an object, such as a photo. To create those views in accordance with the present invention, the user provides a location indication.

The mouse 5 is used to provide location indications. Instead of, or in addition to the mouse 5 another pointing device could be provided, such as a touch pad. Alternatively, cursor keys or a touch screen could be used to provide location indications.

In the present invention, selecting a point on the screen and activating a “create view” function constitutes a request to create a view. The computer or, strictly speaking, the software program being executed by the computer, determines the location and the dimensions of a new view in response to this request. This will further be explained with reference to FIG. 2.

In FIG. 2a, the screen 3 of the computer system of FIG. 1 is schematically shown. On the screen activation points P are displayed, which activation points serve as software buttons for activating the creation of a view. The activation points are, in the embodiment shown, arranged in diagonal rows. When a user selects a particular activation point P, for example by clicking on it, a view is created, in the embodiment shown a rectangular view. In FIG. 2a, the activation point selected by the user is indicated with a circle. It will be understood that this circle is shown for illustration purposes only and need not be displayed on the screen 3.

The view created in response to the encircled activation point P of FIG. 2a being selected is shown in FIG. 2b. As can be seen, the selected point P constitutes the geometric center of the view V. In addition, the view V is made as large as possible so as to fit on the screen, taking top and side margins into consideration. It is noted that the top and side margins do not necessarily have an equal width. As the view V covers its associated activation point P, this activation point is no longer available for creating new views. In this way, overlap of views is avoided.

It is noted that embodiments can be envisaged in which the activation point P does not constitute the center but a corner of a new view, for instance the top left corner. As will be clear from the drawings, in particular FIG. 3 to be discussed later, making the activation point the center of the view avoids overlap.

The selected (encircled) activation point P of FIG. 2a is located in the top left hand corner of the screen 3, and the corresponding view V shown in FIG. 2b is small. A larger view can be created by selecting an activation point P located further away from the edge of the screen 3, for instance the activation point P shown to be encircled in FIG. 2c. The resulting view is shown in FIG. 2d. An even larger view can be created by selecting an activation point P located even further from the edge of the screen 3, as shown in FIGS. 2e and 2f, and the largest view is created by selecting the activation point in the center of the screen 3, as shown in FIGS. 2g and 2h. As can be seen from FIG. 2, the present invention allows the size of a view to be determined by the location of the activation point.

A user will typically want to create multiple views. As will be illustrated with reference to FIG. 3, the present invention allows multiple screens to be created while avoiding overlap.

In FIG. 3a, a single view V₁ is shown and an activation point P is selected (shown encircled). As a result, a second view V₂ is created, as shown in FIG. 3b, where another activation point P is selected from the remaining activation points. The resulting view V₃ is shown in FIG. 3c, where another activation point is selected to create view V₄. As can be seen, the present invention automatically fills the screen with non-overlapping views. Existing views cover, and therefore exclude from selection, activation points which would cause an overlapping view to be created. In addition, the grid structure is chosen so as to maximize the effective use of the screen. Although other grids, such as square grids structures, hexagonal grid structures (preferably with hexagonal views) or triangular grid structures (preferably with triangular views) could be chosen, the structure shown in the figures is particularly advantageous. This structures essentially consists of alternating staggered rows (or columns) of activation points. Alternatively, this grid structure could be considered a diagonal structure.

An alternative embodiment is shown in FIG. 4, where two types of activation points are used: a first type P₁ and a second type P₂. The second type P₂ corresponds with views having the largest possible size, as in FIG. 2, and as illustrated in FIGS. 4c and 4d. The first type P₁, however, corresponds with a view having a fixed, smaller size. Comparing FIGS. 4a and 4b with FIGS. 4e and 4f, the views V₁₁ and V₁₃ have identical dimensions, although the corresponding activation points are located at different distances from the center and the edge of the screen 3. This allows the user to create a smaller view when desired.

A software program for carrying out the method of the present invention may be a separate utility program or may be integrated into the operating system. The software program may be stored on a machine-readable information carrier, such as a floppy disk, a CD-ROM, a zip-disk, a DVD and the like.

The present invention is based upon the insight that a user may indicate the size of a new view by indication its location. The present invention benefits from the further insight that creating views the location and size of which are related provides a very effective way of creating a suitable screen layout for several non-overlapping views.

It is noted that any terms used in this document should not be construed so as limit the scope of the present invention. In particular, the words “comprise(s)” and “comprising” are not meant to exclude any elements not specifically stated. Single (circuit) elements may be substituted with multiple (circuit) elements or with their equivalents. In addition, the word “computer” as used in this document is not limited to desktop computers but is also meant to encompass laptop computers, palmtop computers, PDAs, electronic organizers and other electronic devices comprising a screen and a processor.

It will therefore be understood by those skilled in the art that the present invention is not limited to the embodiments illustrated above and that many modifications and additions may be made without departing from the scope of the invention as defined in the appending claims. `

1. A method of creating a view (V) on a computer screen (3), the method comprising the steps of:
the computer (2) receiving a request from a user to create a view, the request comprising a location indication,
the computer (2) determining, on the basis of the location indication, both a view location and view dimensions, and
the computer (2) displaying a view (V) having said view location and said view dimensions.

2. The method according to claim 1, wherein the location indication comprises a point on the screen indicated by the user.

3. The method according to claim 2, wherein the view has a center which substantially coincides with the point on the screen indicated by the user.

4. The method according to claim 1, wherein the view dimensions are as large as possible.

5. The method according to claim 1, wherein the computer provides view activation points (P) on the screen, each view activation point corresponding with a view having predetermined view dimensions.

6. The method according to claim 5, wherein the computer provides at least two different types of view activation points (P₁, P₂), one type corresponding with views having a fixed size.

7. A device programmed for carrying out the method according to claim 1.

8. The device according to claim 7 which is a desktop computer (1), a laptop computer, a palmtop computer, a PDA or an electronic organizer.

9. A software product for carrying out the method according to claim 1.

10. An information carrier, such as a CD-ROM, provided with a software product according to claim 7.
